(19) United States
(12) Patent Application Publication
(10) Pub. No.: US 2025/0293769 A1
(43) Pub. Date: Sep. 18, 2025

(54) OPTICAL POWER SUPPLY SYSTEM AND FAILURE LOCATION DETECTION METHOD

(71) Applicant: NIPPON TELEGRAPH AND TELEPHONE CORPORATION, TOKYO (JP)

(72) Inventors: Hiroshi WATANABE, Tokyo (JP); Ryo KOYAMA, Musashino-shi, Tokyo (JP); Tomohiro KAWANO, Musashino-shi, Tokyo (JP); Kazuhide NAKAE, Musashino-shi, Tokyo (JP); Saki NOZOE, Musashino-shi, Tokyo (JP); Kazunori KATAYAMA, Musashino-shi, Tokyo (JP)

(73) Assignee: NIPPON TELEGRAPH AND TELEPHONE CORPORATION, TOKYO (JP)

(21) Appl. No.: 18/861,527

(22) PCT Filed: May 6, 2022
(86) PCT No.: PCT/JP2022/019588

§ 371 Date: Oct. 29, 2024

(51) Int. Cl. H04B 10/071; H02J 50/30; H04B 10/25; H04B 10/80

(52) U.S. Cl. CPC H04B 10/071; H02J 50/30; H04B 10/25; H04B 10/807

(57) ABSTRACT

An object of the present disclosure is to make it possible to isolate whether an abnormality has occurred in any one of sections of an optical fiber and a device.

The present disclosure provides an optical power feeding system including: a light source that outputs power feeding light to an optical fiber; a plurality of optical nodes connected in series to the optical fiber; and an optical tester that transmits test light from the light source side of the optical fiber toward the plurality of optical nodes and detects reflected light of the test light, in which each optical node includes: a photoelectric conversion element that converts the power feeding light into electricity; a power storage unit that stores electric power converted by the photoelectric conversion element; an optical switch that switches an output destination of the power feeding light propagated through the optical fiber between the photoelectric conversion element included in the optical node and another optical node connected to the optical fiber; a control unit that switches connection of the optical switch in accordance with a control signal superimposed on the power feeding light; and a test light cut filter that reflects, toward the optical tester, the test light output from the optical switch to the photoelectric conversion element.

### TECHNICAL FIELD

The present disclosure relates to an optical power feeding system that feeds power to a plurality of optical nodes by connecting the optical nodes in series to an optical fiber.

### BACKGROUND ART

In an optical fiber network, particularly an access network connecting a communication device installed in a communication building and a communication terminal on a user side, optical fiber line switching such as connection to a new route or a change in route is performed at a constant frequency in order to efficiently use equipment in opening or maintenance thereof. While such work is generally performed manually at the site for switching of the connection of the optical fiber, a technology for remotely switching connection of an optical fiber has been proposed.

For example, Non Patent Literatures 1 and 2 propose a method in which, in a system constituted by a power feeding control light source installed in a power supply environment such as inside a station and one or a plurality of optical nodes remotely arranged, the plurality of optical nodes are connected in series to an optical fiber, so that functions of optical power feeding and control of a plurality of optical switches included in the optical nodes can be simultaneously implemented with a single light source. These optical nodes are installed in an optical fiber network, and perform mutual connection and switching in units of optical fibers.

### CITATION LIST

### Non Patent Literature

Non Patent Literature 1: “Shorai hikari akusesumo ni muketa enkaku kouro kirikae node no kentou (in Japanese) (Study on Remote Optical Path Switching Node for Optical Access Network in Future)”, The Institute of Electronics, Information and Communication Engineers (IEICE) General Conference, 2021 B-13-16

Non Patent Literature 2: “Enkaku kouro kirikae nodes no chokuretsu setsuzoku housiki ni kansuru ichi kento (in Japanese) (Study on Series Connection Method of Remote Optical Path Switching Nodes)”, The Institute of Electronics, Information and Communication Engineers (IEICE) General Conference, 2022 B-13-28

### SUMMARY OF INVENTION

### Technical Problem

In an optical fiber network constituted by optical nodes, in a case where some abnormality such as a failure occurs in any of the optical nodes or the optical fiber connecting the optical nodes, it is necessary to detect the point of the abnormality for restoration. However, there is currently no method or system for detecting an abnormal point in an optical fiber network constituted by optical nodes.

In addition, in a case of restoration in which it is assumed that an abnormal point is to be efficiently restored on-site an outdoor facility, it is required that the abnormal point be detected without rework (error in position of dispatch such as entering a manhole again and again) at the time of dispatching personnel for the restoration, such as a distance to each portion of the optical nodes or the abnormal point in an optical cable, and thus, it is required to isolate the position from a remote place with high accuracy. Furthermore, the optical nodes, which are configured to be driven by optical power feeding light, are required to be driven in a power-saving manner, and thus, methods and systems are desirable in which an abnormal point is detected only by a currently provided function, without the need for newly providing a sensor or the like for abnormality detection.

It is an object of the present disclosure to enable detection of an abnormal point from a distance in an optical power feeding system that feeds power to a plurality of optical nodes by connecting the optical nodes in series to an optical fiber.

### Solution to Problem

The present disclosure provides an optical power feeding system that feeds power to a plurality of optical nodes by connecting the optical nodes in series to an optical fiber, and includes a communication device and optical nodes of the present disclosure.

The present disclosure provides a communication device including:
a light source that outputs power feeding light to a plurality of optical nodes connected in series to an optical fiber; and
an optical tester that transmits test light from the light source side of the optical fiber toward the plurality of optical nodes and detects reflected light of the test light, in which
a point where an optical loss has occurred is determined by using a test waveform obtained by the optical tester, and
an abnormal point is determined on the basis of the point where the optical loss has occurred.

The present disclosure provides an optical node device including:
a photoelectric conversion element that converts power feeding light propagated through an optical fiber into electricity;
a power storage unit that stores electric power converted by the photoelectric conversion element;
an optical switch that switches an output destination of the power feeding light between the photoelectric conversion element included in an optical node and another optical node connected to the optical fiber;
a test light cut filter that reflects test light output from the optical switch to the photoelectric conversion element; and
a control unit that switches connection of the optical switch in accordance with a control signal superimposed on the power feeding light, checks a voltage value of power stored in the power storage unit at regular time intervals, and automatically switches the optical switch to the photoelectric conversion element included in the optical node when the voltage value of the power stored in the power storage unit becomes equal to or less than a certain value.

The present disclosure provides an abnormal point detection method executed by the optical power feeding system of the present disclosure, in which
the plurality of optical nodes includes:
an optical switch that switches an output destination of the power feeding light propagated through the optical fiber between the photoelectric conversion element included in the optical node and another optical node connected to the optical fiber; and
a test light cut filter that reflects, toward the optical tester, the test light output from the optical switch to the photoelectric conversion element,
a control unit included in any one of the plurality of optical nodes switches connection of the optical switch in accordance with a control signal superimposed on the power feeding light, and
the test light is reflected by the test light cut filter.

In the optical power feeding system of the present disclosure, the control unit may check a voltage value of power stored in the power storage unit at regular time intervals, and may automatically switch the optical switch to the photoelectric conversion element included in the optical node when the voltage value of the power stored in the power storage unit becomes equal to or less than a certain voltage value.

In the optical power feeding system of the present disclosure, a point where an optical loss has occurred may be determined by using a test waveform obtained by the optical tester, information regarding a distance of the optical fiber from the optical tester to each one of the plurality of optical nodes may be referenced and the point where the optical loss has occurred may be compared with the information regarding the distance, and
(i) in a case where an abnormality has occurred in any one of the plurality of optical nodes, the optical node where the abnormality has occurred may be determined, and
(ii) in a case where an abnormality has occurred in any one of sections between optical nodes among the plurality of optical nodes, the section of the optical fiber where the abnormality has occurred may be determined.

The control signal superimposed on the power feeding light may be used to switch, for each one of the plurality of optical nodes sequentially from a side closer to the light source, the optical switch to the photoelectric conversion element included in the optical node, and
in a case where there is no reflection of the test light in the optical node in which switching to the photoelectric conversion element has been performed, it may be determined that an abnormality has occurred in the optical node.

In the optical power feeding system of the present disclosure, the test light may be transmitted from the optical tester in a periodic manner or in a case where a response from an optical node to the control signal superimposed on the power feeding light is not received from any one of the plurality of optical nodes.

In this case, in a case where no optical loss has occurred in the test waveform obtained by the optical tester, for each one of the plurality of optical nodes sequentially from the side closer to the light source, the optical switch may be switched to the photoelectric conversion element included in the optical node.

Note that the disclosures described above can be combined in any possible manner.

### Advantageous Effects of Invention

According to the present disclosure, in an optical power feeding system that feeds power to a plurality of optical nodes by connecting the optical nodes in series to an optical fiber, it is possible to detect an abnormal point from a distance.

### BRIEF DESCRIPTION OF DRAWINGS

FIG. 1 is a basic configuration example of an optical power feeding system.

FIG. 2 is an example of functional blocks of the optical power feeding system.

FIG. 3 is a system configuration example of the optical power feeding system according to the present disclosure.

FIG. 4 is a system configuration example of the optical power feeding system according to the present disclosure.

FIG. 5 is a system configuration example of the optical power feeding system according to the present disclosure.

FIG. 6 is a flowchart illustrating an example of an abnormal point detection method according to the present disclosure.

### DESCRIPTION OF EMBODIMENTS

Hereinafter, embodiments of the present disclosure will be described in detail with reference to the drawings. Note that the present disclosure is not limited to the following embodiments. These embodiments are merely examples, and the present disclosure can be carried out in forms of various modifications and improvements based on knowledge of those skilled in the art. Note that components having the same reference numerals in the present specification and the drawings indicate the same components.

### Basic Configuration Example of Optical Power Feeding System

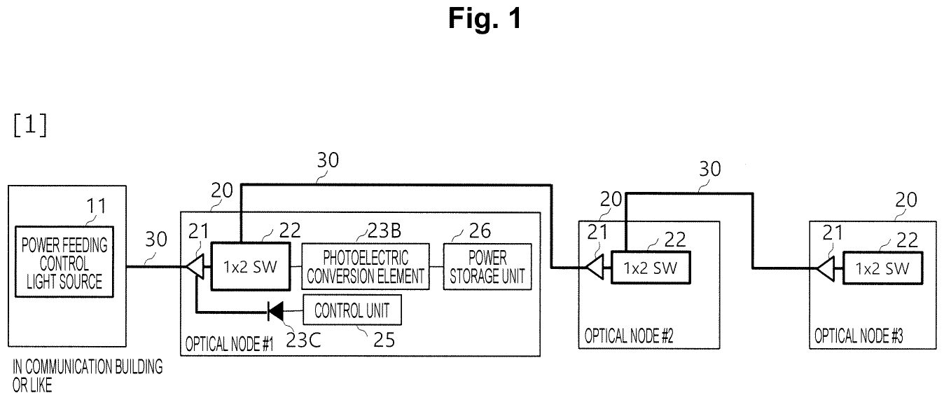

FIG. 1 illustrates a basic configuration example of an optical power feeding system. The optical power feeding system of the present disclosure includes a power feeding control light source 11 that outputs power feeding light to a power feeding/controlling optical fiber 30, and a plurality of optical nodes 20 connected in series to the power feeding/controlling optical fiber 30. The present embodiment shows, for easy understanding, an example in which only three optical nodes 20 are connected, and the number of optical nodes 20 connected in series may be 2 or more and is optional.

Each optical node 20 includes:
an optical coupler 21 that bifurcates power feeding light;
a photoelectric conversion element 23B that converts the power feeding light into electricity;
a power storage unit 26 that stores electric power converted by the photoelectric conversion element 23B;
a 1×2 optical switch 22 that switches an output destination of the power feeding light propagated through the power feeding/controlling optical fiber 30 between the photoelectric conversion element 23B included in the optical node 20 and another optical node 20 connected to the power feeding/controlling optical fiber 30;
a photoelectric conversion element 23C that receives a control signal superimposed on the power feeding light; and
a control unit 25 that switches connection of the 1×2 optical switch 22 in accordance with the control signal received by the photoelectric conversion element 23C.

Hereinafter, the photoelectric conversion elements 23B and 23C will be referred to as the photoelectric conversion elements 23 in a case where the photoelectric conversion elements are not distinguished from each other.

Optical power feeding light emitted from the power feeding control light source 11 in a remote location such as in a communication building is sequentially connected to the plurality of optical nodes 20 by a single power feeding/controlling optical fiber 30. Each optical node 20 is provided with the 1×2 optical switch 22, and switches whether to take the transmitted optical power feeding light into the photoelectric conversion elements 23 of each optical node 20 or to send the transmitted optical power feeding light to the subsequent optical node 20. This switching of the 1×2 optical switch 22 is performed by a control signal superimposed on the optical power feeding light. As described above, a control signal causes the 1×2 optical switch 22 to be switched so that the power feeding control light source 11 and each optical node 20 can communicate on a one-to-one basis at a time.

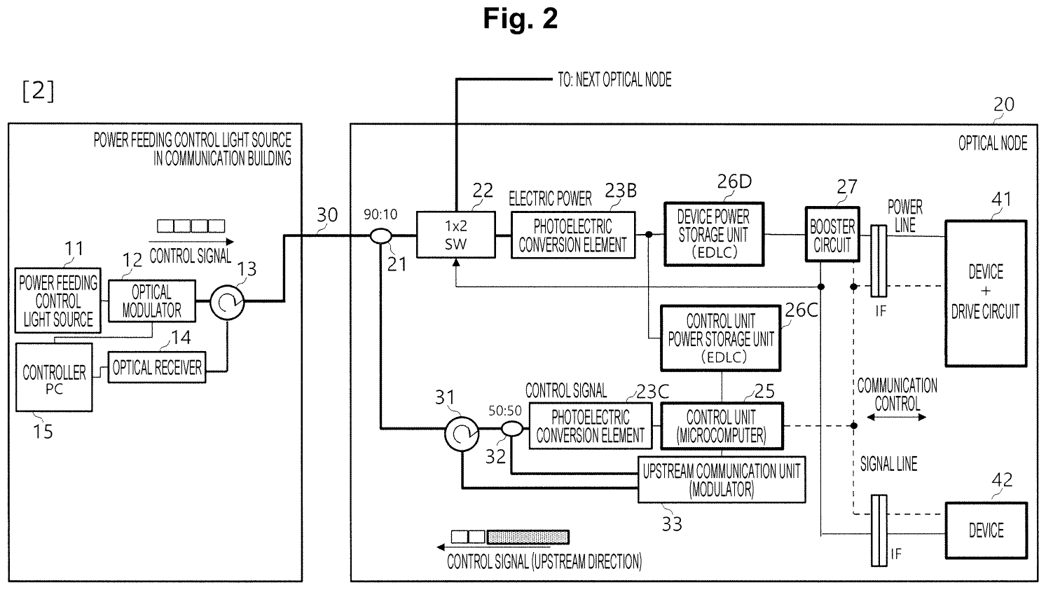

A more detailed configuration of the optical power feeding system is illustrated in FIG. 2. Optical power feeding light from the power feeding control light source 11 in a communication building is transmitted to the optical node 20, with a control signal superimposed on the optical power feeding light by an optical modulator 12. A control signal in the upstream direction from the optical node 20 is output from a circulator 13 to an optical receiver 14, and is received by the optical receiver 14. A controller PC 15 outputs a control signal to the optical modulator 12, and the optical modulator 12 superimposes the control signal on the power feeding light. The optical receiver 14 outputs the received signal to the controller PC 15. Thus, the controller PC 15 transmits and receives a control signal to and from each optical node 20.

The control unit 25 of the optical node 20 receives a control signal superimposed on optical power feeding light, and controls the 1×2 optical switch 22 and other devices 41 and 42. Furthermore, the optical node 20 converts the optical power feeding light into electricity in the photoelectric conversion element 23B, and stores the electricity in a device power storage unit 26D and a control unit power storage unit 26C. The control unit 25 and the devices 41 and 42 of the optical node 20 are driven by the stored electric power. Here, in the present disclosure, the device power storage unit 26D and the control unit power storage unit 26C will be referred to as the power storage unit 26 in a case where the power storage units are not distinguished from each other.

The control unit 25 and the devices 41 and 42 cannot be controlled or driven when the voltage is equal to or less than a drivable voltage value. The configuration in FIG. 1 includes the plurality of optical nodes 20, and the 1×2 optical switches 22 are sequentially switched so that optical power feeding can be performed for all the optical nodes 20. The optical power feeding system of the present disclosure is therefore based on the assumption that the power storage unit 26 included in each optical node 20 always stores a certain amount of power, and the control unit 25 included in each optical node 20 is maintained in a drivable state.

In addition, in order to ensure that the power storage unit 26 of each optical node 20 always stores a constant amount of power, the optical power feeding system of the present disclosure causes the power feeding control light source 11 to use a control signal to make an inquiry at any time to the optical node 20 to check the amount of power stored in the power storage unit 26.

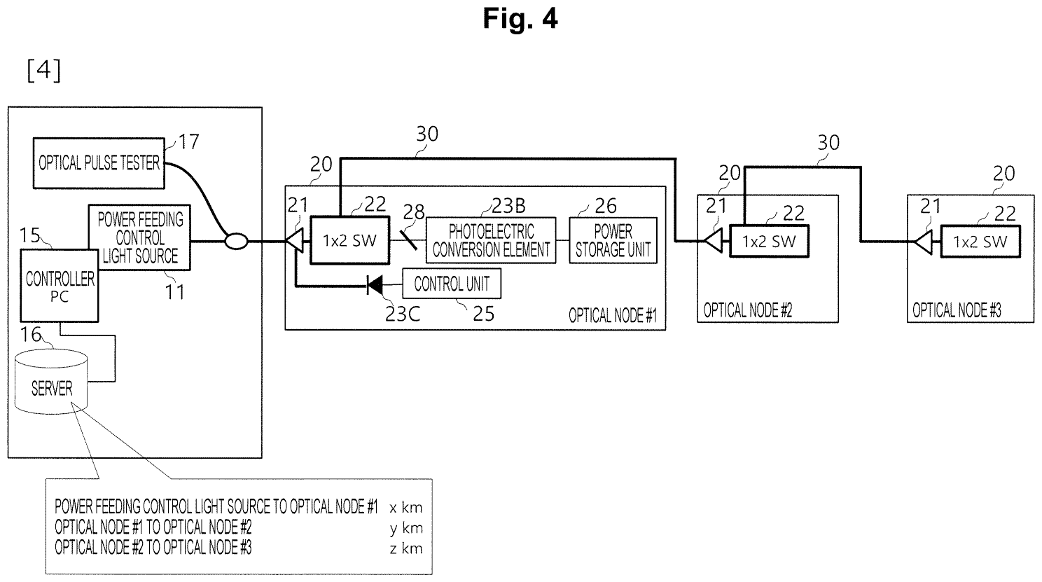

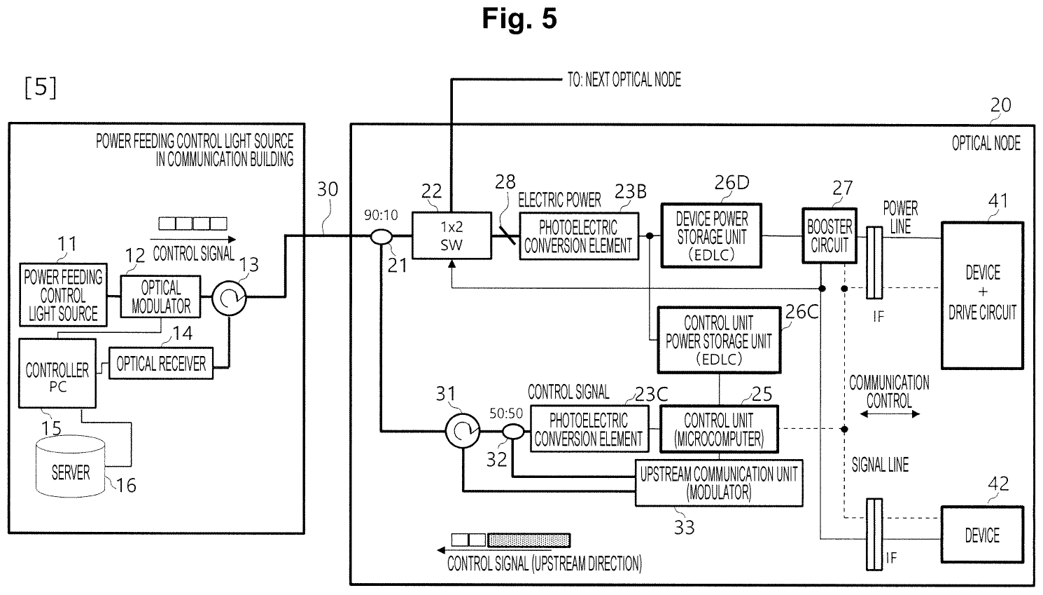

The optical power feeding system of the present disclosure further includes an optical tester (optical pulse tester 17 illustrated in FIG. 4) and a test light cut filter (reference numeral 28 in FIGS. 4 and 5) in addition to the optical power feeding system illustrated in FIGS. 1 and 2. In the present embodiment, an example using an optical pulse tester (reference numeral 17 in FIG. 4) will be described as an example of the optical tester. The optical pulse tester (reference numeral 17 in FIG. 4) transmits test light from the power feeding control light source 11 side of the power feeding/controlling optical fiber 30 toward the plurality of optical nodes 20, and detects reflected light of the test light. The test light cut filter (reference numeral 28 in FIGS. 4 and 5) reflects, toward the optical pulse tester 17, test light output from the 1×2 optical switch 22 to the photoelectric conversion element 23B.

The optical power feeding system of the present disclosure executes an abnormal point detection method of the present disclosure. For example, in the abnormal point detection method of the present disclosure, the control unit 25 switches the connection of the 1×2 optical switch 22 in accordance with a control signal superimposed on power feeding light, so that test light is reflected by the test light cut filter 28.

The optical power feeding system of the present disclosure includes the optical pulse tester (reference numeral 17 in FIG. 4) and the test light cut filter (reference numeral 28 in FIGS. 4 and 5), and executes the abnormal point detection method of the present disclosure, thereby enabling isolation of a failure from a remote place only with currently provided functions as illustrated in FIGS. 1 and 2 in a case where an abnormality occurs in any of sections of the power feeding/controlling optical fibers and the devices of the optical nodes 20 connected in series in an optical fiber network constituted by the optical nodes 20.

### First Embodiment for Carrying out Invention

A first embodiment of the optical power feeding system of the present disclosure will be described in detail. As described above, each optical node 20 drives the control unit 25 and the devices 41 and 42 in the optical node 20 by the electric power stored in the power storage unit 26. In each optical node 20, in a case where the optical node 20 is not receiving optical power feeding light, that is, in a case where the 1×2 optical switch 22 has been switched to the subsequent optical node 20 side, the electric power stored in the power storage unit 26 decreases with time due to self-discharge or the like.

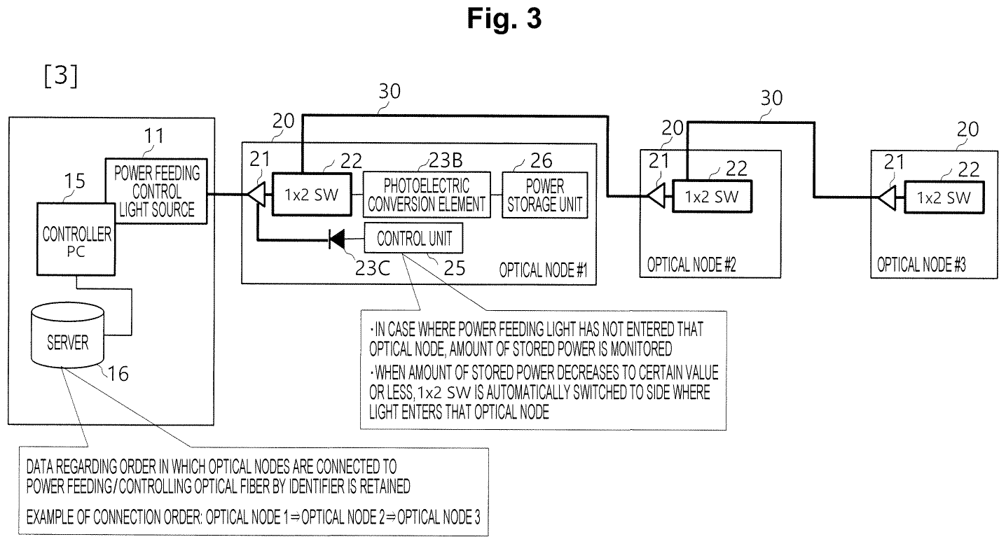

In the present embodiment, as illustrated in FIG. 3, in a case where any one of the optical nodes 20 is not receiving optical power feeding light, the control unit 25 checks the voltage value of power stored in the power storage unit 26 at regular time intervals, and when the voltage value becomes equal to or less than a certain voltage value, the control unit 25 can automatically switch the 1×2 optical switch 22 to a direction in which the optical node 20 can receive the optical power feeding light.

As a result, in a case where any one of the optical nodes 20 continues to fail to receive optical power feeding light and the voltage value of the power storage unit 26 of the optical node 20 further drops, causing the control unit 25 to become undrivable due to the voltage drop or the 1×2 optical switch 22 to become unable to be driven, the 1×2 optical switch 22 of the corresponding optical node 20 is switched to a direction in which the optical node 20 can receive the optical power feeding light.

### Second Embodiment for Carrying out Invention

A second embodiment of the optical power feeding system of the present disclosure will be described in detail. In the first embodiment, as illustrated in FIG. 3, a server 16 that cooperates with the controller PC 15 for operating the power feeding control light source 11 is installed. The server 16 cooperates with the controller PC 15 and retains information regarding the connection order of the plurality of optical nodes 20 from the power feeding control light source 11 with a single optical fiber.

The optical nodes 20 are provided with unique identifiers, and the server 16 retains the order in which the optical nodes are connected. In the example in FIG. 3, the server 16 stores that an optical node 20 #1 is an identifier, and that the optical nodes 20 are connected to the power feeding/controlling optical fiber 30 in the order of the optical node 20 #1, an optical node 20 #2, and an optical node 20 #3.

### Third Embodiment for Carrying out Invention

A third embodiment of the optical power feeding system of the present disclosure will be described in detail. In the second embodiment, as illustrated in FIG. 4, pulse test light of a specific test wavelength can be inserted into the power feeding/controlling optical fiber 30 from the upper side of the optical node 20 #1 in a communication building or the like by the optical pulse tester 17. In addition, the optical node 20 is provided with the test light cut filter 28 such as a fiber grating (FBG) that blocks light of the test wavelength by reflecting the light.

A more detailed configuration of the optical power feeding system is illustrated in FIG. 5. As illustrated in FIG. 5, the test light cut filter 28 is interposed between the 1×2 optical switch 22 and the photoelectric conversion element 23B in the optical node 20. With this configuration, the pulse test light reaches the 1×2 optical switch 22. In a case where the inserted pulse test light reaches the test light cut filter 28, a reflection point is confirmed at the position of the test light cut filter 28 in a pulse test waveform, so that it is possible to confirm that the pulse test light has reached.

As illustrated in FIG. 4, the server 16 that cooperates with the controller PC 15 for operating the power feeding control light source 11 has data regarding optical fiber lengths (line lengths) between the power feeding control light source 11 and the nearest optical node 20 #1, and between the optical nodes 20.

As described above, in transmission and reception of a control signal between the power feeding control light source 11 and any one of the optical nodes 20, in a case where a failure such as no response from the optical node 20 occurs, the optical pulse tester 17 performs an optical pulse test on the power feeding/controlling optical fiber 30. In a case where a location where an optical loss has occurred is confirmed with the test waveform, the server 16 measures the distance between the power feeding control light source 11 and the location where the optical loss has occurred. The distance to the point where the loss has occurred measured by the optical pulse tester 17 is compared with the connection order of the optical nodes 20 and the line length of the corresponding power feeding/controlling optical fiber 30 managed by the server 16, and thus it is possible to isolate the optical node 20, or the optical nodes 20 between which is the area of the optical fiber, where an optical loss has occurred.

### Fourth Embodiment for Carrying out Invention

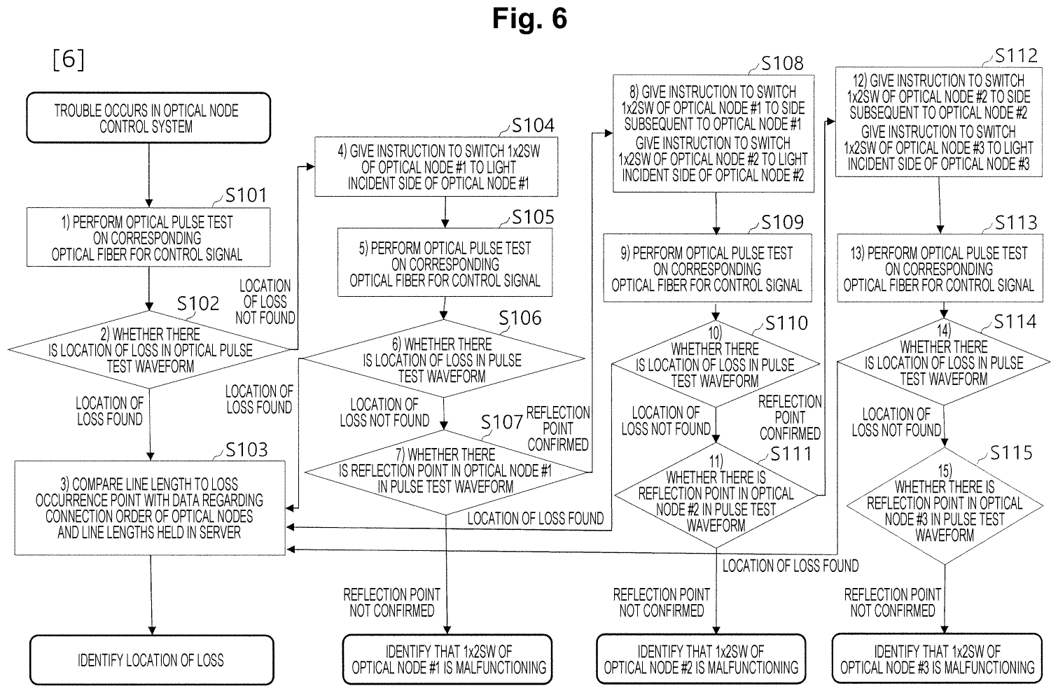

A fourth embodiment of the optical power feeding system of the present disclosure will be described in detail. In the third embodiment, the server 16 executes an isolation flow illustrated in FIG. 6. The server 16 can also be implemented by a computer and a program, and the program can be recorded in a recording medium or provided through a network. In a case where the program is executed by the controller PC 15, it is also possible to adopt a configuration in which the controller PC 15 has the function of the server 16.

In the present embodiment, three optical nodes 20 are connected. As described above, an optical pulse test is performed using the optical pulse tester 17 (S101), and a test waveform obtained by the optical pulse test is used to confirm whether there is a location where an optical loss has occurred (S102). In a case where a location of an optical loss is confirmed, the abnormal point is detected by comparison with data stored in the server 16 (S103). In a case where there is no location where an optical loss has occurred, confirmation is sequentially performed from the optical node 20 #1 that is closer to the power feeding control light source 11.

First, a control signal is used to instruct the optical node 20 #1 to switch the 1×2 optical switch 22 to the light incident side of the optical node 20 #1 (S104). Even in a case where the amount of stored power at this time point is not enough to allow the power storage unit 26 of the optical node 20 #1 to make a response, as long as the optical node 20 #1 is operating normally, the 1×2 optical switch 22 should be automatically switched to a direction in which the optical node 20 can receive light, due to the characteristics described in the first embodiment.

Next, an optical pulse test is performed (S105), and a test waveform obtained by the optical pulse test is used to confirm whether there is a location where an optical loss has occurred (S106). In a case where a location of an optical loss is confirmed (a location where a loss has occurred is found in S106), comparison with the data stored in the server 16 is performed (S103), and the abnormal point is detected. In a case where no location of an optical loss is confirmed (no location where a loss has occurred is found in S106), the reflection point in the optical node 20 #1 is confirmed with the test waveform (S107).

Here, in a case where the 1×2 optical switch 22 has been switched normally to the direction in which the optical node 20 can receive light, the reflection from the test light cut filter 28 installed in a stage subsequent to the 1×2 optical switch 22 should be able to be confirmed at the far end of the test waveform (the reflection point is found in S107). In a case where the reflection point is not confirmed (no reflection point is found in S107), the 1×2 optical switch 22 has not been switched to the direction in which the optical node 20 can receive light. It is therefore determined that there is a possibility that some abnormality has occurred in the optical node 20 #1. In a case where the reflection point is confirmed, it is determined that the 1×2 optical switch 22 of the optical node 20 #1 is normal, and confirmation for the optical node 20 #2 is performed next.

An instruction is given to switch the 1×2 optical switch 22 of the optical node 20 #1 to the side subsequent to the optical node 20 #1 (S108). In addition, an instruction is given to switch the 1×2 optical switch 22 of the optical node 20 #2 to the light incident side of the optical node 20 #2 (S108). Thereafter, an optical pulse test is performed (S109), and confirmation of a location of an optical loss (S110) and confirmation of the reflection point in the optical node 20 #2 (S111) are performed as in steps S106 and S107. In a case where no abnormality is found in the optical node 20 #2 (the reflection point is confirmed in S111), next, isolation of an abnormal point is performed in the optical node 20 #3 by a similar method (S112 to S115).

### Fifth Embodiment for Carrying out Invention

A fifth embodiment of the optical power feeding system of the present disclosure will be described in detail. The fourth embodiment is characterized in an event that triggers the start of an isolation flow, in which the isolation flow is irregularly started with occurrence of an event as a trigger, for example, when a trouble occurs in a control system of the optical nodes 20, control communication for making an inquiry or a response about the amount of stored power or the like is exchanged between the power feeding control light source 11 and each optical node 20, but no response is received from the optical node 20.

### Sixth Embodiment for Carrying out Invention

A sixth embodiment of the optical power feeding system of the present invention will be described in detail. The fourth embodiment is characterized in an event that triggers the start of an isolation flow, for example, on the assumption that maintenance or the like is periodically performed, the isolation flow is periodically performed with the lapse of a certain time since execution of the previous isolation flow as a trigger.

### REFERENCE SIGNS LIST

11 Power feeding control light source
12 Optical modulator
13 Circulator
14 Optical receiver
15 Controller PC
16 Server
17 Optical pulse tester
20 Optical node
21 Optical coupler
22 1×2 optical switch
23, 23B, 23C Photoelectric conversion element
25 Control unit
26 Power storage unit
26D Device power storage unit
26C Control unit power storage unit
27 Booster circuit
41, 42 Device

1. An optical power feeding system comprising:
a light source that outputs power feeding light to an optical fiber;
a plurality of optical nodes connected in series to the optical fiber; and
an optical tester that transmits test light from the light source side of the optical fiber toward the plurality of optical nodes and detects reflected light of the test light, wherein
each one of the plurality of optical nodes includes:
a photoelectric conversion element that converts the power feeding light into electricity;
a power storage unit that stores electric power converted by the photoelectric conversion element;
an optical switch that switches an output destination of the power feeding light propagated through the optical fiber between the photoelectric conversion element included in the optical node and another optical node connected to the optical fiber;
a control unit that switches connection of the optical switch in accordance with a control signal superimposed on the power feeding light; and
a test light cut filter that reflects, toward the optical tester, the test light output from the optical switch to the photoelectric conversion element.

2. The optical power feeding system according to claim 1, wherein
the control unit checks a voltage value of power stored in the power storage unit at regular time intervals, and automatically switches the optical switch to the photoelectric conversion element included in the optical node when the voltage value of the power stored in the power storage unit becomes equal to or less than a certain voltage value.

3. An abnormal point detection method executed by an optical power feeding system, the optical power feeding system including:
a light source that outputs power feeding light to an optical fiber;
a plurality of optical nodes connected in series to the optical fiber; and
an optical tester that transmits test light from the light source side of the optical fiber toward the plurality of optical nodes and detects reflected light of the test light,
in which in the plurality of optical nodes,
a photoelectric conversion element converts the power feeding light into electricity, and
a power storage unit stores electric power converted by the photoelectric conversion element, wherein
the plurality of optical nodes includes:
an optical switch that switches an output destination of the power feeding light propagated through the optical fiber between the photoelectric conversion element included in the optical node and another optical node connected to the optical fiber; and
a test light cut filter that reflects, toward the optical tester, the test light output from the optical switch to the photoelectric conversion element,
a control unit included in any one of the plurality of optical nodes switches connection of the optical switch in accordance with a control signal superimposed on the power feeding light, and
the test light is reflected by the test light cut filter.

4. The abnormal point detection method according to claim 3, wherein
a point where an optical loss has occurred is determined by using a test waveform obtained by the optical tester,
information regarding a distance of the optical fiber from the optical tester to each one of the plurality of optical nodes is referenced and the point where the optical loss has occurred is compared with the information regarding the distance, and
(i) in a case where an abnormality has occurred in any one of the plurality of optical nodes, the optical node where the abnormality has occurred is determined, and
(ii) in a case where an abnormality has occurred in any one of sections between optical nodes among the plurality of optical nodes, the section of the optical fiber where the abnormality has occurred is determined.

5. The abnormal point detection method according to claim 4, wherein
the control signal superimposed on the power feeding light is used to switch, for each one of the plurality of optical nodes sequentially from a side closer to the light source, the optical switch to the photoelectric conversion element included in the optical node, and
in a case where there is no reflection of the test light in the optical node in which switching to the photoelectric conversion element has been performed, it is determined that an abnormality has occurred in the optical node.

6. The abnormal point detection method according to claim 5, wherein
the test light is transmitted from the optical tester in a periodic manner or in a case where a response from an optical node to the control signal superimposed on the power feeding light is not received from any one of the plurality of optical nodes, and
in a case where no optical loss has occurred in the test waveform obtained by the optical tester, for each one of the plurality of optical nodes sequentially from the side closer to the light source, the optical switch is switched to the photoelectric conversion element included in the optical node.

7. (canceled)

8. An optical node device comprising:
a photoelectric conversion element that converts power feeding light propagated through an optical fiber into electricity;
a power storage unit that stores electric power converted by the photoelectric conversion element;
an optical switch that switches an output destination of the power feeding light between the photoelectric conversion element included in an optical node and another optical node connected to the optical fiber;
a test light cut filter that reflects test light output from the optical switch to the photoelectric conversion element; and
a control unit that switches connection of the optical switch in accordance with a control signal superimposed on the power feeding light, checks a voltage value of power stored in the power storage unit at regular time intervals, and automatically switches the optical switch to the photoelectric conversion element included in the optical node when the voltage value of the power stored in the power storage unit becomes equal to or less than a certain value.
